(19) United States
(12) Patent Application Publication
(10) Pub. No.: US 2002/0078126 A1
(43) Pub. Date: Jun. 20, 2002

(54) Broadband interconnection system

(76) Inventor: Thomas Higgins, Dublin (IE)

Correspondence Address: JACOBSON, PRICE, HOLMAN & STERN, PROFESSIONAL LIMITED LIABILITY COMPANY, 400 SEVENTH STREET N.W., WASHINGTON, DC, 20004, US

(21) Appl. No.: 10/013,512

(22) Filed: Dec. 13, 2001

Related U.S. Application Data
(63) Continuation of application No. PCT/IE00/00077, filed on Jun. 15, 2000.

(30) Foreign Application Priority Data
Jun. 15, 1999 (IE) 990491

(51) Int. Cl. G06F 15/16

(52) U.S. Cl. 709/200

(57) ABSTRACT

A broadband interconnection system (1) allows an operator provide services to subscribers having systems (10). A controller (2) maintains and controls resources (3, 6, 8) via drivers (2, 5, 7) providing a uniform interface. A driver (9) provides a link for direct upgrading or registration of subscriber services. A message bus (24) is common to a path for operator personnel interactivity and subscriber interactivity, and to device-level maintenance data. The controller (2) uses a different path for software and data downloads to a subscriber system.

### INTRODUCTION

1. Field of the Invention

The invention relates to a broadband interconnection system for management of services provided by an operator to subscribers, either directly or via another operator. The operator may be a telecoms, a mobile phone, a cable TV, or a satellite TV operator.

2. Prior Art Discussion

Heretofore, provision of such services to subscribers has typically required a large extent of personnel time and it has been difficult to extend the range of services provided. For example the cable TV area, provision of Internet services has involved work by technicians at both the head end and the subscriber end to set up service by installing a cable mode and registering it at the head end.

Therefore, the invention is directed towards providing a broadband interconnection system which:

allows simpler interconnection between disparate devices such as cable modems, XDSL, set-top boxes, and wireless devices and disparate systems or resources for services such as billing and customer management,

allows more subscriber service versatility, and

reduces required operator manpower.

### SUMMARY OF THE INVENTION

According to the invention, there is provided a broadband interconnection system for an operator providing services to remote subscribers, the system comprising:

a message bus;

a subscriber interface comprising means for interfacing with subscribers and for placing messages in the message bus;

an administration interface comprising means for interfacing with operator personnel and for placing messages in the message bus;

a controller comprising means for communicating with resources via drivers, in which the drivers provide a uniform interface to the controller; and

means in the controller for interactively registering and upgrading subscriber services on the resources in response to requests transmitted from subscribers or operator personnel via the message bus.

In one embodiment, the subscriber interface and the administration interface comprise a common Web server, and the subscriber interface further comprises a network router for routing of messages via a network.

In one embodiment, the system comprises a listener thread for both the subscriber and the administration interfaces, said listener thread comprising means for delivering messages to the message bus. in one embodiment, the system comprises a plurality of request broker threads comprising means for picking messages from the message bus and for delivering them to the controller.

In one embodiment, the request broker threads comprise means for transmitting a confirmation to a message source.

In one embodiment, the request broker threads comprise means for transmitting the confirmation via a Common Gateway Interface.

In one embodiment, the message bus comprises means for communicating in a message format having name-value pairs following a header indicating the operation to be performed on values in the name-value pairs.

In one embodiment, the message bus comprises means for writing messages to memory in a contiguous linked list and for reading back the messages on a first-in-first-out basis, and means for providing an exclusive lock to a thread for an update operation.

In one embodiment, the system further comprises a device interface comprising means for automatically capturing subscriber system device-level data and for processing said data to maintain a subscriber system maintenance database.

In one embodiment, the device-level interface comprises a data trap linked with a router modem and it comprises means for directing messages to the message bus.

In one embodiment, the data trap is an SNMP trap connected to a cable router.

In one embodiment, the controller comprises means for directing programs and data to a subscriber system via a driver, in which the subscriber system is registered with the controller as a resource.

In one embodiment, the controller comprises means for generating a subscriber configuration file and for transmitting said file to a subscriber system in response to a subscriber self-registration or self-service upgrade request.

In one embodiment, said configuration file comprises means for allowing a subscriber system cable modem to filter subscriber access to services.

In one embodiment, the subscriber interface comprises a lying DNS server comprises means for direction of a subscriber browser to a default operator Web page for self-registration or service upgrade.

In one embodiment, the controller comprises business objects for implementing business logic and system component objects for modelling system components.

In one embodiment, the controller comprises objects for managing the resources via the drivers.

In one embodiment, the drivers comprise means for returning an undo message to a controller object, and an object comprises means for rolling back using said undo messages to perform atomic transactions.

According to another aspect the invention provides a method for subscriber self-registration to operator services, the method comprising the steps of:

a subscriber accessing a Web server via a communication network provided by the operator and inputting a service request,

the Web server routing the service request to a controller; and

the controller processing the request and downloading a subscriber configuration file to a subscriber system via a driver, in which the subscriber system is registered as a resource of the controller.

In one embodiment, the Web server routes the service to the controller via a listener thread, a message bus, and a request broke thread.

In one embodiment, the message protocol for the message bus comprises an operation identifier in a header followed by a plurality of name-value field pairs.

### DETAILED DESCRIPTION OF THE INVENTION

### BRIEF DESCRIPTION OF THE DRAWINGS

The invention will be more clearly understood from the following description of some embodiment thereof given by way of example only with reference to the accompanying drawings in which:

FIG. 1 is a diagram illustrating the structure of a subscriber operator management system; and

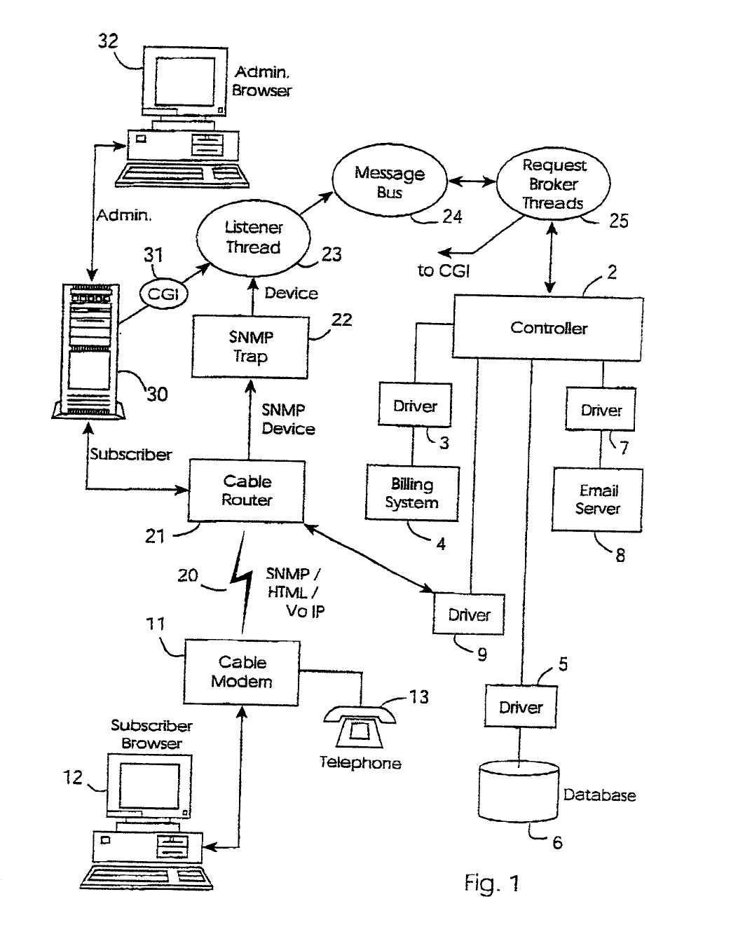

FIG. 2 is a flow diagram illustrating interactivity of subscriber systems and the operator management system.

### DESCRIPTION OF THE EMBODIMENTS

Referring to the drawings, there is shown a broadband interconnection system 1, in this case for a cable TV operator. The system 1 allows interconnection between disparate devices such as cable modems, XDSL devices, set-top boxes and wireless devices and disparate systems or resources for services such as billing, customer management, Web mail, VoIP, VOD, and games.

The system 1 comprises a controller programmed to implement operator business logic to manage a range or services to subscribers in a versatile manner. These services are provided by resources linked to the controller by drivers. A driver 3 links the controller 2 with a billing system 4. A driver 5 links it with a relational database 6, and a driver 7 links it with an email server 8. There resources are given by way of example and it will be appreciated that the controller 2 may be linked with other resources such as news, video, games, customer care, marketing, or IP telephony servers.

The drivers each comprise an API providing a uniform interface to the controller 2, and the resource-side interface may be of any appropriate type, depending on the particular resource.

The controller 2 is also connected to a driver 9 which allows it to communicate with a subscriber system, treating the subscriber system as a resource. This is described in more detail below.

A subscriber system 10 comprises a cable modem 11 connected to a PC-based browser 12 having an Internet browser and to a telephone 13. The cable modem 11 communicates via a cable network 20 with a head-end cable router 21. The cable router 22 is linked with a Simple Network Message (SNMP) trap 22, in turn linked with a listener thread (LT) 23. The latter is linked with a message bus 24, in turn linked with request broker threads (RBTs) 25. The RBTs 25 in turn communicate with the controller 2.

In another route from the cable router 21, a Web server 30 incorporating a lying Domain Name Server (DNS) uses a Common Gateway Interface (CGI) function 31 to communicate with the LT 23.

Finally, administration workstations 32 running browsers are also linked with the Web server 30.

the controller 2 comprises application business logic implemented by business objects. There are also component objects, each modelling a component of the system such as a cable router. There is also an object for management of subscribers, and a management object associated with each resource.

Each object is an instance of a C++ class. The objects are held in a dynamic library that can be linked to application logic written also in C++. In addition, each object is accessible iva a CORBA interface. CORBA allows to system objects from any other machine, either local or remote, that implements CORBA. In effect this allows the system to be controlled by software running on a wide variety of machines and operating systems and coded in a range of languages from Java, C to scripting languages such as Python™ and Perl™. Using Python™ for example allows the operator to devise and implement additional business rules in a simple language and thereby extend the system according to the requirements.

To perform its operations the controller objects interface to the drivers. All drivers present a uniform message interface to the controller objects. Most drivers reside on the same platform as the controller objects and are loaded as dynamic libraries at runtime. However, each driver can be optionally loaded on a different machine and converted into a CORBA server, thus allowing distribution of load and the option to code the drivers on differing operating systems and languages. Thus the system is not limited to being implemented as pure C++ or C programs.

In addition for every message that a driver understands the driver can generate an Undo Message that allows the operation to be “rolled back”. This facility allows the drivers to transparently take part in atomic transactions. A single business rule might require updates to be posted to a number of different drivers. These multiple updates form a single transaction. If any one update of a transaction fails then it is a requirement to “roll back” the updates already performed within the transaction. This is done by running the Undo Messages that were returned by the drivers for each update operation.

There are four interconnection routes or channels for interactivity provided by the interconnection system 1. These are as follows. (a) Subscriber browser 12 to controller 2, via cable modem 11, cable router 21, Web server 30, CGI 31, LT 23, MB 24, and RBT 25. This allows subscriber interactivity.

(b) Subscriber device-to-controller 2, via cable modem 11, cable router 21, SNMP trap 22, LT 23, MB 24, and RBT 25. This allows machine-level (device-level) data capture over a wide area for maintenance purposes.

(c) Subscriber-to-controller 2 without the browser 12, via telephone voice to an administration person who uses the workstation 32 to access the controller 2 via the Web server 30, the CGI 31, the LT 24, and the RBT 25. This allows an operator administration person to perform registration and/or service update operations on behalf of a subscriber.

(d) Controller-to-subscriber configuration file download, via the driver 9, the cable router 21, and the cable modem 11. This allows automatic updating of a subscriber system from a resource, interconnectivity again being provided by the interconnection system 1.

Three of these routes are thought he LT 23, the MD 24, and the RBTs 25. The MB 24 comprises a C++ program utilizing RAM and providing automatic mirroring to disk. The messages are written to the memory in a contiguous linked list manner with FIFO organization. The message bus program implements a locking mechanism giving exclusive access to the LT 23 or an RBT 25 for updates. The message format is as follows:

| | | | | | | | |
|---|---|---|---|---|---|---|---|
| | Oper- | | | | | ... Field | |
| Source | ation | Field 1 | Field 1 | Field 2 | Field 2 | n | Field n |
| ID | ID | ID | Value | ID | Value | ID | Value |

This may be referred to as a name-value pair schema, in which the name is the Field Identifier and the Value i is that for Field i. The pairs are preceded by an identifier for the message source and an identifier for the operation to be performed on the Field Values. It has been found that this provides a particularly effective messaging mechanism in the system 1 between the LT 23, the MD 24, and the RBTs 25 because other formats are easily converted to this format for routing through this single pipe or channel. It is also suitable for fast MB 24 interfacing.

The following describes the content of CUI messages and the expected message responses. Each message is described in a format as follows:

| SubId | <MESSAGE SUB_ID> |
|---|---|
| Name | Type |
| <NAME 1> | S |
| <NAME 2> | I |
| <NAME 3> | L |

The particular GUI message is uniquely identified by the SubId. The name of each Name-Value pair is the listed along with the Value's type. The type can be one of the following:

S—String

I—Integer

L—List of Values

The expected response is documented in a similar fashion, with the SubId always being set to SUCCESS!

All unexpected responses (i.e. errors) will follow the format below:

| SubId | FAILURE |
|---|---|
| Name | Type |
| ERROR_CODE | I |

The following is a message to login a user to the system:

| SubId | USER_LOGIN |
|---|---|
| Name | Type |
| OPERATOR | S |
| IP_ADDRESS | S |
| USER_NAME | S |
| PASSWORD | S |

Expected response:

| SubId | SUCCESS |
|---|---|
| Name | Type |
| SESSION_ID | S |

The following is a message to logout a user:

| SubId | USER_LOGOUT |
|---|---|
| Name | Type |
| IP_ADDRESS | S |
| SESSION_ID | S |

Expected response:

| | |
|---|---|
| SubId | SUCCESS |

The following is a message for a CSR to create a new subscriber:

| SubId | SUBSCRIBER_ADD_CSR |
|---|---|
| Name | Type |
| IP_ADDRESS | S |
| SESSION_ID | S |
| OPERATOR | S |
| MODEM_MAC_ADDRESS | S |
| FIRST_NAME | S |
| LAST_NAME | S |
| PASSWORD | S |
| ADDRESS_1 | S |
| ADDRESS_2 | S |
| CITY | S |
| STATE | S |
| POST_CODE | S |
| COUNTRY | S |
| HOME_PHONE | S |
| CREDIT_CARD_NUMBER | S |
| CREDIT_CARD_EXPIRY | S |
| CREDIT_CARD_NAME | S |

Expected response:

| SubId | SUCCESS |
|---|---|
| Name | Type |
| ACCOUNT_NUMBER | S |

The following is a message to update a subscriber in the system:

| SubId | SUBSCRIBER_UPDATE |
|---|---|
| Name | Type |
| IP_ADDRESS | S |
| SESSION_ID | S |
| OPERATOR | S |
| ACCOUNT_NUMBER | S |
| FIRST_NAME | S |
| LAST_NAME | S |
| PASSWORD | S |
| ADDRESS_1 | S |
| ADDRESS_2 | S |
| CITY | S |
| STATE | S |
| POST_CODE | S |
| COUNTRY | S |
| HOME_PHONE | S |
| CREDIT_CARD_NUMBER | S |
| CREDIT_CARD_EXPIRY | S |
| CREDIT_CARD_NAME | S |

Expected response:

| | |
|---|---|
| SubId | SUCCESS |

The message bus may alteratively be of a type in which messages are placed on a physical bus for routing between the threads.

The LT 23 and the RBTs 24 comprise a thread program residing on a platform having a Unix operating system and a Sun Solaris™ hardware platform. The program controls a total of fifteen threads one of which is the LT 23 and the remaining fourteen are the RBTs 25. The request broking operations involve interaction with the controller 2 and various drivers and so are processor-intensive. Provision of multiple RBTs (configurable) ensures that performance is adequate. Scaleability may be achieved by either:

(i) increasing the number of threads, or

(ii) adding additional thread prods in a modular manner, with the Webserver 30, the SNMP trap 22, and the controller 2 programmed to select a particular program according to traffic load management criteria.

As stated above, routes (a), (c), and (d) above use the LT/MB/RBT link. In addition, the route (a) uses the subscriber's browser 12, the cable modem 11, and the cable router 21 to access the Web server 30. The Web server 30 uses the CGI protocol to communicate with the CGI function 31, and the later uses the MB message protocol described above. The Web server 30 treats html accesses from the administration workstations 32 like those from the subscriber PC 12 for the route (c) The subscriber voice call uses VoIP via the cable modem 11.

The route (b) is quite different. It uses SNMP over IP for transmission of a maintenance or fault signal from the cable modem 11 (without subscriber input) to the trap 22 and thence to the LT 23. This allows the controller 2 to gather detailed device-level (machine-level) maintenance inputs for all of the subscriber system in the field independently of the subscriber himself or herself. The controller 2 dynamically maintains a database of subscriber device data for maintenance and upgrade purposes.

Finally, the route (d) is a download of data and/or programs from the controller 2 to the subscriber systems using the driver 9 and the cable router 21. This is a very direct and simple route, allowing effective downloads to take place even if the files are large.

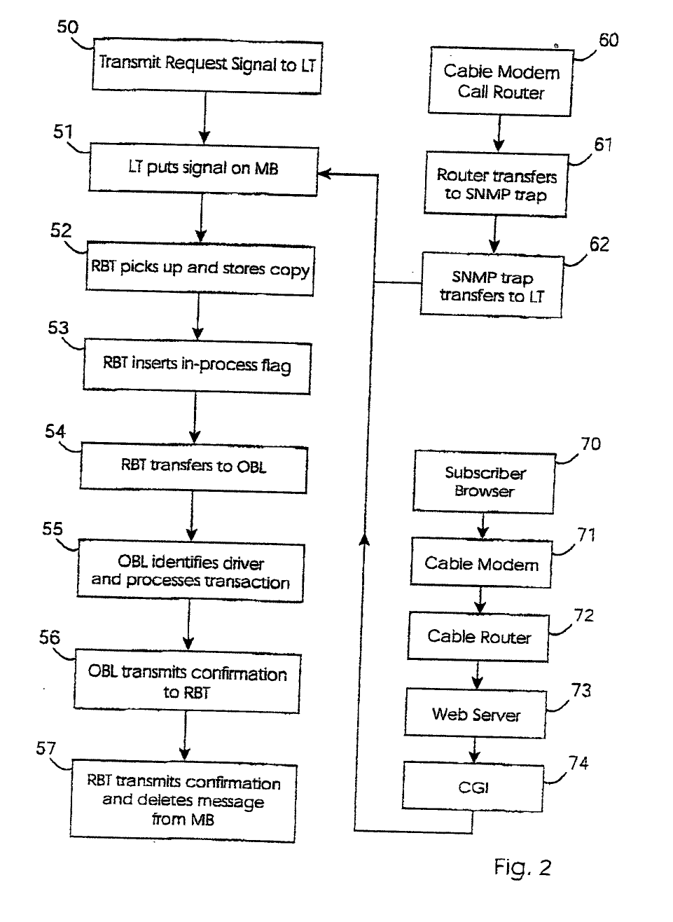

Referring now to FIG. 2, for interaction of an administration person with the controller 2 in step 50 the browser 32 accesses the Web server 30 which in turn uses the CGI function 31 to route the message to the LT 23 in the MB format. In step 51 the LT 23 delivers the message to the MB 24 and locally stores a copy of it in step 52, and in step 53 inserts an in-process flag. The RBT 25 then transfers the message to the controller 2 (“Operator Business Logic” (OBL)) in step 54. The operation identified in the usage header is used by the controller 2 to identify the relevant resource (5) and associated drivers and process the transaction by interfacing with them in step 55. In step 56 the controller 2 transmits a confirmation to the RBT 25. In step 57 the RBT 25 in turn transmits a confirmation back to the CGI 31 using a separate CGI link 58. The RBT 25 also deletes the message from the MB 24 after transmission of the confirmation. Steps 50 to 57 set out the sequence for route (c) above. This is typically used by the subscriber making a voice call in a Voice over Internet Protocol (VoIP) format over the cable network 20. It arises where the subscriber does not have a PC or where he or she does not wish to use a PC.

For device or machine-level alerts or notifications (route (b)), in step 60 the cable modem 11 calls the cable router 21, and in step 61 the router 21 transfers the (SNMP) message to the trap 22. The trap 22 in turn transfers the message to the LT 23 in step 62. There, the route in completed by the steps 51 to 56. In this case there in no confirmation back to the cable modem 11 as the LT 23 is one-way only.

The route (a) involves use of the subscriber browser 12 in step 70. The cable modem 12 inserts the system 1 URL as a default and html is routed in steps 71 and 72 through the cable modem 11 and the cable router 21 to the Web server 30 in step 73. The Web server 30 in step 74 activates the CGI function 31, and the remainder of the link comprises steps 51 to 57 as for the route (c).

An unimportant aspect of the route (c) is that it allows subscriber to both register themselves with the system 1 and to perform service updates without the need for the operator to send an employee to the subscriber's premises or even to involve an employee in-house. For self-registration, the subscriber is forwarded a cable modem 11 with a driver program. The subscriber connects the cable modem 11 to the PC 12 and installs the driver program. He or she then opens a conventional browser on the PC 12. The browser uses the operator's URL by default because the cable modem 11 accesses the lying DNS server residing on the Web server 30. This URL causes automatic download of registration pages. As forms are filed in on-screen, the Web server 30 interfaces with the controller 2 as described for route (a). Completion of a form involves a subscriber selecting service options such as an Internet access service or an email service. The controller 2 verifies the subscriber according to the details inputted and correlation with a record associated with the cable modem ID, which is automatically recognized.

The range of available services is set by the range of resources linked to the controller 2 by drivers. When the selection/acceptance registration phase is complete the controller 2 downloads a configuration file using route (d) to the cable modem 11. This file thence causes the cable modem 11 to act as an access controller to allow or block service requests according to the subscribers profile. The configuration file sets not only the valid services, but also the manner in which some of them are used. An example is the Internet bandwidth.

It will thus be appreciated that the system 1 allows an operator to vary the range of services offered in a dynamic and flexible manner. It also allows very simple registration of subscribers with little operator manpower requirements. Another advantage is that the controller 2 gathers comprehensive device-level maintenance data without need for subscriber input.

In more general terms, the system provides for broadband interconnection of disparate devices and resources to act as a mediator, a platform, and an adapter. As a mediator, the system 1 de-couples hardwired integrations between each of the many systems, device, network and data integration endpoints required by operators to provide interactive services. The system 1 effectively acts as the broker between each of the integration endpoints thereby reducing the overall number of integrations and insulating each integration endpoint from the specific details of the others. The system 1 proves both active and reactive mediation services. Through active mediation the system 1 can initiate and control integration with an integration endpoint (for example open an account in the billing system). Through reactive mediation the system 1 can respond to an event generated by an integration endpoint (for example cable modem power up, network, or alarm).

The resources which may be easily added include customer care, marketing, report-generators, news, interactive TV, IP telephony, video, and games resources. Some of these are used directly to provide subscriber services (for example IP telephony) and others are used internally for administration (for example marketing).

As a platform, the system 1 provides an environment on which the operator-specific business processes are hosted. The platform provides the necessary high level, and equipment-and system-neutral, services for a business process to start, execute and interface with any integration endpoint. A business process can start in response to any event (for example from a system or device, by another process, as scheduled). A business process can interface with an integration endpoint generically. The system 1 exposes a high level generic interface to the business process which insulates the business process from the details of a specific integration endpoint and simplifies business process implementation.

As an adapter, the system 1 exposes high-level generic interfaces that encapsulate the implementation details of specific underlying integration endpoints. The system 1 performs the necessary conversions to adapt a generic interface to a specific integration endpoint.

An adapter can map an interface to one or many alternative integration endpoints. Through this design, one integration endpoint may be substitutes by an alternative and any interface (for example a business process) remains unaffected by that substitution. This design exposes interfaces that are implementation vendor neutral.

For example, a billing system driver (or adapter) might expose a public generic Account Open interface. The adapter would adapt that generic interface to private specific interfaces for billing systems A and B. A and B may be interchanged and the generic interface and any specific would remain unchanged.

The drivers (or adapters) are either Inlets or Outlets. Inlet adapters normally channel events into the system 1 from integration endpoints (e.g. an alarm) generically. Outlet adapters normally channel control or data out from the system 1 to integration endpoints (e.g. a billing system) generically.

The versatility provided by the mediation, platform, and adapt functions of the system 1 allows it to be used for not only direct operator to subscriber interaction, but also indirect interaction via a different operator system.

The invention is not limited to the embodiments described but may be varied in construction and detail.

1. A broadband interconnection system (1) for an operator providing services to remote subscribers, the system comprising:
a message bus (24);
a subscriber interface comprising means for interfacing with subscribers and for placing messages in the message bus;
an administration interface (21, 30) comprising means for interfacing with operator personnel and for placing messages in the message bus (24); and
a controller (2) comprising means for communicating with resources (3, 6, 8) via drivers, in which the drivers provide a uniform interface to the controller; and
means in the controller for interactively registering and upgrading subscriber services on the resources in response to requests transmitted from subscribers or operator personnel via the message bus (24).

2. A system as claimed in claim 1, wherein the subscriber interface and the administration interface comprise a common Web server (30), and the subscriber interface her comprises a network router (21) for routing of messages via a network (20).

3. A system as claimed in claim 1, wherein the system comprises a listener thread (23) for both the subscriber and the administration interfaces, said listener thread comprising means for delivering messages to the message bus (24).

4. A system as claimed in claim 3, where the system comprises a plurality of request broker threads (25) comprising means for picking messages from the message bus (24) and for delivering then to the controller (2).

5. A system as claimed in claim 3, wherein the request broker threads (25) comprise means for trasmitting a confirmation to a message source.

6. A system as claimed in claim 5, wherein the request broker threads comprises means for transmitting the confirmation via a Common Gateway Interface of the subscriber interface and the administration interface.

7. A system as claimed in claim 1, wherein the message bus comprises means for communicating in a message format having name-value pairs following a header indicating the operation to be performed on values in the name-value pairs.

8. A system as claimed in claim 7, wherein the message bus (24) comprises means for writing messages to memory in a contiguous lined list and for reading back the messages on a first-in-first-out basis, and means for providing an exclusive lock to a thread for an update operation.

9. A system as claimed in claim 1, wherein the system further comprises a device interface (21, 22) comprising means for automatically capturing subscriber system device-level data and for processing said data to maintain a subscriber system maintenance database.

10. A system as claimed in claim 9, wherein the device-level interface comprises a data trap (22) linked with a router modem (21) and comprises means for directing messages to the message bus.

11. A system as claimed in claim 10, wherein the data trap (22) is an SNMP trap connected to a cable router.

12. A system as claimed in claim 1, wherein the controller comprises means for directing programs and data to a subscriber system via a driver (9), in which the subscriber system (10) is registered with the controller as a resource.

13. A system as claimed in claim 12, wherein the controller comprises means for generating a subscriber configuration file and for transmitting said file to a subscriber system (10) in response to a subscriber self-registration or self-service upgrade request.

14. A system as claimed in claim 13, wherein said configuration file comprises means for allowing a subscriber system cable modem to filter subscriber access to services.

15. A system as claimed in claim 13, wherein the subscriber interface comprises a lying DNS server comprising means for direction of a subscriber browser to a default operator Web page for self-registration or service upgrade.

16. A system as claimed in claim 1, wherein the controller comprises business objects for implementing business logic and system component classes for modelling system components.

17. A system as claimed in claim 16, wherein the controller comprises objects for managing the resources via the drivers.

18. A system as claimed in claim 1, wherein the drivers comprise means for returning an undo message to a controller object, and an object comprises means for rolling back using said undo messages to perform atomic transactions.

19. A method for subscriber self-registration to operator services, the method comprising the steps of:
a subscriber accessing a Web server via a communication network provided by the operator and inputting a service request, the Web server routing the service request to a controller; and
the controller processing the request and downloading a subscriber configuration file to a subscriber system via a driver, in which the subscriber system is registered as a resource of the controller.

20. A method as claimed in claim 19, wherein the Web server routes the service to the controller via a listener thread, a message bus, and a request broker thread.

21. A method as claimed in claim 20, wherein the message protocol for the message bus comprises an operation identifier in a header followed by a plurality of name-value field pairs.

22. A computer program product comprising software code portions for performing operations of a broadband interconnection system as claimed in any of claims 1 to 18 when executed on a digital computer.

23. A computer program product comprising software code portions for performing the steps of any of claims 19 to 21 when run on a digital computer.
